(19) United States
(12) Patent Application Publication
(10) Pub. No.: US 2021/0313562 A1
(43) Pub. Date: Oct. 7, 2021

(54) Amorphous Silicon in Solid Electrolytes, Compositions and Anodes

(71) Applicant: Nanostar Inc., New Orleans, LA (US)

(72) Inventor: Jonathan Goodman, Evanston, IL (US)

(73) Assignee: Nanostar Inc., New Orleans, LA (US)

(21) Appl. No.: 16/939,846

(22) Filed: Jul. 27, 2020

Related U.S. Application Data
(60) Provisional application No. 63/006,274, filed on Apr. 7, 2020.

(51) Int. Cl. H01M 4/36; H01M 4/134; H01M 10/0562; H01M 4/136; H01M 4/133

(52) U.S. Cl. CPC H01M 4/364; H01M 4/134; H01M 2004/021; H01M 4/136; H01M 4/133; H01M 10/0562

(57) ABSTRACT

Herein are described compositions, anodes and batteries utilizing a plurality of amorphous silicon nanocrystals and a solid electrolyte. These compositions provide anode and batteries that have improved first columbic efficiencies when compared to analogous systems prepared with crystalline silicon nanocrystals. The methods of the production of the admixtures, the anodes and the cells/batteries are also provided.

### CROSS-REFERENCE TO RELATED APPLICATIONS

This disclosure claims the benefit of priority to U.S. Patent Application No. 63/006,274, filed 7 Apr. 2020, the entirety of which are incorporated herein.

### FIELD OF THE INVENTION

The present invention relates to the structure, composition, and formation of silicon-based anodes made with a solid electrolyte and suitable for a lithium ion battery.

### BACKGROUND

Rechargeable Li-ion batteries have revolutionized the energy-storage market and enabled the widespread use of portable electronic devices and electric vehicles. Replacing the liquid electrolyte in conventional Li-ion batteries with a solid electrolyte (SE) can further improve their energy densities and safety by reducing flammability, improving the cycle life, and enabling the use of alkali-metal anodes. Unlike current organic liquid electrolytes, inorganic SEs are non-flammable and/or have much higher onset temperatures for thermal runaway. Notably, the reactivity of liquid electrolytes with electrodes also contributes substantially to battery capacity fade.

The incorporation of conventional anodic materials, e.g., graphite, with SEs has produced some improvements but the capacity of graphite is a continuing, limiting factor to the development of high energy density cells. Accordingly, silicon and lithium metal have been investigated as additives or replacements of graphite in the anode; each of these bring their own chemistries and challenges to the formation of a stable high-energy density cell.

### SUMMARY

A first embodiment is an admixture for use in an anode of a lithium ion battery which features about 20 wt. % to about 75 wt. % of a plurality of amorphous silicon nanocrystals; and about 80 wt. % to about 25 wt. % of a solid electrolyte.

A second embodiment is an admixture for use in an anode of a lithium ion battery which features a plurality of amorphous silicon nanocrystals individually carrying a surface coating that is less than 50 atom % silicon; and a solid electrolyte.

A third embodiment is an anode, for use in lithium ion batteries, which features an admixture of a plurality of amorphous silicon nanoparticles and a solid electrolyte; the admixture adhered to a current collector; wherein the anode has not undergone an initial-charging cycle.

A fourth embodiment is a cell utilizing an anode which includes an admixture of a plurality of amorphous silicon nanoparticles and a solid electrolyte; the admixture adhered to a current collector; wherein the cell has a first columbic efficiency greater than about 90%, 91%, 92%, 93%, 94%, 95%, 96%, 97%, 98%, or 99%.

A fifth embodiment is a process of preparing an anode for use in a lithium ion battery which features providing a plurality of amorphous silicon nanocrystals; providing a solid electrolyte; admixing the plurality of amorphous silicon nanocrystals and the solid electrolyte; and then affixing the admixture to a current collector.

### BRIEF DESCRIPTION OF THE FIGURES

For a more complete understanding of the disclosure, reference should be made to the following detailed description and accompanying drawing figures wherein:

FIG. 1 is a pictorial representation of an amorphous silicon nanocrystal 100 having some crystalline silicon domains 102 carried in an amorphous silicon domain 101;

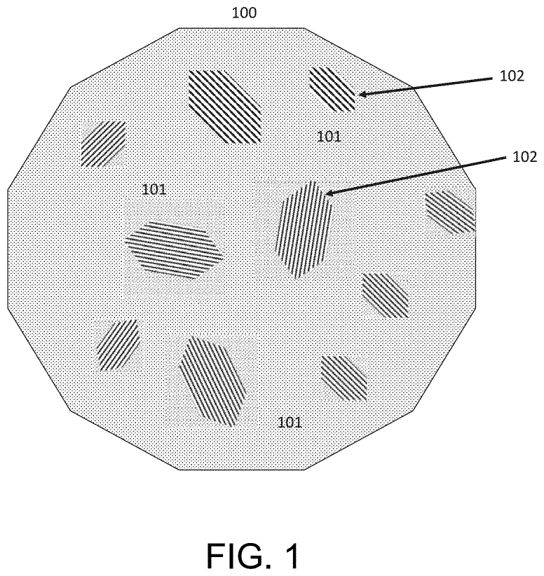

FIG. 2 is a pictorial representation of an amorphous silicon nanocrystal 200 carrying a surface coating 203 and having some crystalline silicon domains 202 carried in an amorphous silicon domain 201; and

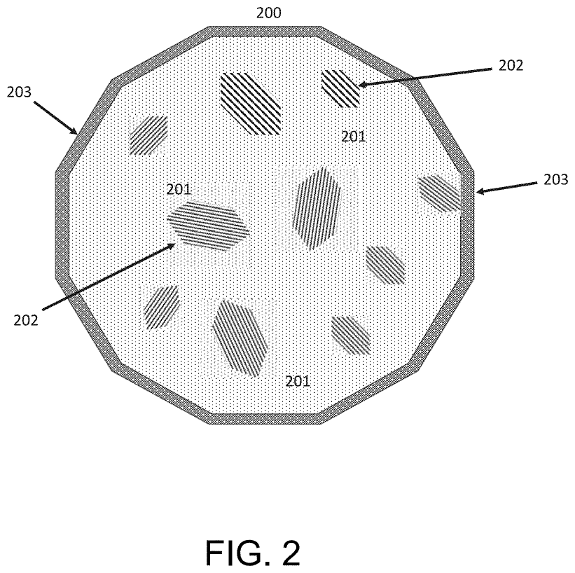

FIG. 3 is a pictorial representation of an anode 300 that includes an admixture of a plurality of amorphous silicon nanocrystals 301 carried in a solid electrolyte 302, optionally including a binder or conductive agent 303, where the admixture is carried on a current collector 304.

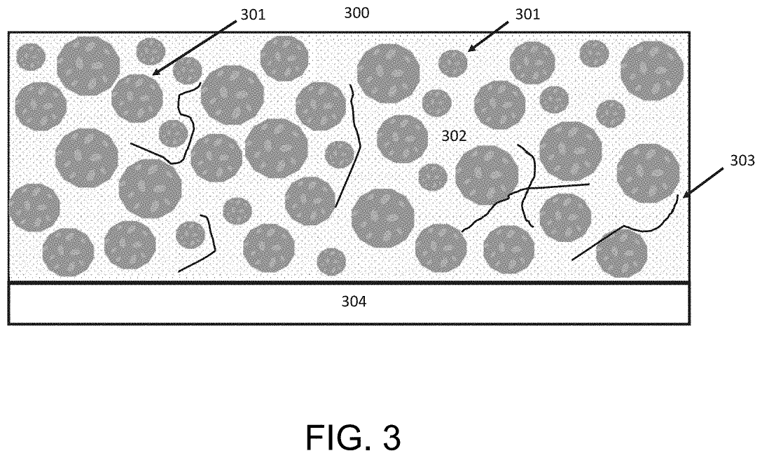

While specific embodiments are illustrated in the figures, with the understanding that the disclosure is intended to be illustrative, these embodiments are not intended to limit the invention described and illustrated herein.

### DETAILED DESCRIPTION

Objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

Herewith are disclosed solutions to some of the challenges of incorporating silicon into a solid-state battery. Notably, improvements to the interface between anodic silicon and the electrolyte are describes and a solution to irreversible loss during initial cycling is addressed. The interface stability and/or binding of the silicon to the electrolyte are addressed by forming a coherent layer that is compositional analogous to the solid electrolyte on the surface of the anodic silicon. In one embodiment, this bonding layer is a silicon sulfide that interacts with a sulfide based solid electrolyte. Further, irreversible loss during the initial cycling of a solid-state system has been reduced or eliminated by the utilization of an amorphous silicon nanoparticle.

One embodiment of the invention described herein is an admixture for use in an anode of a lithium ion battery. The admixture includes, consists essentially of, or consists of a plurality of amorphous silicon nanocrystals and a solid electrolyte. In one instance, the admixture includes about 10 wt. % to about 90 wt. % amorphous silicon nanocrystals. The admixture can include about 10 wt. % to about 80 wt. %, about 10 wt. % to about 75 wt. %, about 15 wt. % to about 75 wt. %, about 20 wt. % to about 75 wt. %, about 25 wt. % to about 75 wt. %, about 30 wt. % to about 65 wt. %, about 30 wt. % to about 50 wt. %, or about 40 wt. % to about 50 wt. % amorphous silicon nanocrystals. In another instance, the admixture includes about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. % amorphous silicon nanocrystals. The admixture can further include about 90 wt. % to about 10 wt. % solid electrolyte; in another example the admixture includes about 90 wt. % to about 20 wt. %, about 90 wt. % to about 25 wt. %, about 85 wt. % to about 25 wt. %, about 80 wt. % to about 25 wt. %, about 75 wt. % to about 25 wt. %, about 70 wt. % to about 35 wt. %, about 70 wt. % to about 50 wt. %, or about 60 wt. % to about 50 wt. % solid electrolyte. In another instance, the admixture includes about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. % solid electrolyte.

The amorphous silicon nanocrystals, preferably, have an average diameter of less than about 1,000 nm, 900 nm, 800 nm, 700 nm, 600 nm, 500 nm, 400 nm, 300 nm, or 250 nm. In another instance, the amorphous silicon nanocrystals have an average diameter of from about 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, or 100 nm to about 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, or 1,000 nm. In specific instances, the amorphous silicon nanocrystals preferably have an average diameter of about 50 nm to about 1,000 nm, about 50 nm to about 800 nm, about 50 nm to about 750 nm, about 50 nm to about 700 nm, about 50 nm to about 650 nm, about 50 nm to about 600 nm, about 50 nm to about 550 nm, about 50 nm to about 500 nm, about 50 nm to about 450 nm, about 50 nm to about 400 nm, about 50 nm to about 350 nm, about 50 nm to about 300 nm, about 100 nm to about 750 nm, about 100 nm to about 600 nm, about 100 nm to about 500 nm, about 100 nm to about 400 nm, or about 100 nm to about 300 nm. In one instance, amorphous silicon nanocrystals have a spherical morphology. In another instance, the amorphous silicon nanocrystals can have a plate-like morphology.

Amorphous silicon nanocrystals are, preferably, composed of greater than about 70 wt. %, about 90 wt. %, about 95 wt. %, about 98 wt. %, about 99 wt. %, about 99.5 wt. %, or about 99.9 wt. % silicon. In one instance, the amorphous silicon nanocrystals consist essentially of silicon. In another instance, the amorphous silicon nanocrystals consist of silicon. In one example, the amorphous silicon nanocrystals include amorphous hydrogenated silicon (a-Si:H). In another example, the amorphous silicon nanocrystals include n-doped or p-doped silicon.

In still another instance, the amorphous silicon nanocrystals include a silicon alloy. The silicon alloy can be a binary alloy (silicon plus one alloying element), can be a tertiary alloy, or can include a plurality of alloying elements. The silicon alloy is understood to include a majority silicon. A majority silicon particle means that the metal has a weight percentage that is greater than about 50% (50 wt. %) silicon, preferably greater than about 60 wt. %, 70 wt. %, 80 wt. %, 90 wt. %, 95 wt. %, 96 wt. %, 97 wt. %, 98 wt. %, 99 wt. %, or 99.5 wt. % silicon; these can include silicon alloys that comprise silicon and at least one alloying element. The alloying element can be, for example, an alkali metal, an alkaline-earth metal, a Group 13 to 16 element, a transition element, a rare earth element, or a combination thereof, but not Si. The alloying element can be, e.g., Li, Na, Mg, Ca, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, B, Al, Ga, In, Ge, Sn, P, As, Sb, Bi, S, Se, Te, or a combination thereof. In one instance, the alloying element can be lithium, magnesium, aluminum, titanium, vanadium, chromium, manganese, iron, cobalt, nickel, copper, or a mixture thereof. In another instance, the silicon alloy can be selected from SiTiNi, SiAlMn, SiAlFe, SiFeCu, SiCuMn, SiMgAl, SiMgCu, or a combination thereof.

Notably, the amorphous silicon nanocrystals may include a plurality of domains (e.g., identifiable by techniques like TEM). In one example, the amorphous silicon nanocrystals consist essentially of amorphous silicon domains. In another example, the amorphous silicon nanocrystals consist of amorphous silicon domains. In still another example, the individual amorphous silicon nanocrystals can include amorphous silicon domains and crystalline silicon domains. Preferably, the ratio of the amorphous silicon domains to crystalline silicon domains is in the range of about 1:1 to about 1000:1, about 1:1 to about 900:1, about 1:1 to about 800:1, about 1:1 to about 700:1, about 1:1 to about 600:1, about 1:1 to about 500:1, about 1:1 to about 400:1, about 1:1 to about 300:1, about 1:1 to about 200:1, about 1:1 to about 100:1, about 1:1 to about 50:1, about 1:1 to about 25:1, about 1:1 to about 20:1, about 1:1 to about 15:1, about 1:1 to about 10:1, about 1:1 to about 9:1, about 1:1 to about 8:1, about 1:1 to about 7:1, about 1:1 to about 6:1, about 1:1 to about 5:1, about 1:1 to about 4:1, about 1:1 to about 3:1, about 1:1 to about 2:1, about 2:1 to about 25:1, about 2:1 to about 20:1, about 2:1 to about 15:1, about 2:1 to about 10:1, or about 2:1 to about 5:1. Notably, the ratio can be on a volume basis and/or on an atom basis. In one instance, the ratio is an atom ratio. Preferably, the ratio is both a volume and atom basis.

The crystalline silicon domains, preferably, have an average crystalline domain size of less than about 40 nm, about 30 nm, about 20 nm, 15 nm, or 10 nm. In another example,

the average crystalline domain size is between about 5 nm to about 50 nm, about 5 nm to about 40 nm, about 5 nm to about 30 nm, about 5 nm to about 25 nm, about 10 nm to about 25 nm, or about 10 nm and about 20 nm.

In one instance, the solid electrolyte includes a sulfide solid electrolyte. The sulfide solid electrolyte can include a lithium-phosphorous-sulfur electrolyte, for example, a thio-Li superionic conductor (LISICON)-type compound, for example having the formula Li₄₋ₓM₁₋ₓPₓS₄ (M=Ge, Si), Li₁₀GeP₂S₁₂ (LGPS), Li_{9.54}Si_{1.74}P_{1.44}S_{11.7}Cl_{0.3} and derivatives thereof. In one preferable example, the sulfide solid electrolyte includes a Li₂S—P₂S₅ glass and/or a Li₇P₃S₁₁ glass-ceramic. In still another preferable example, the sulfide solid electrolyte can include an argyrodite structure, for example having the formula Li₆PS₅X (X=F, Cl, Br, I), and/or having a non-argyrodite structure, for example having the formula Li_{7-x-2y}PS_{6-x-y}Xₓ (X=F, Cl, Br, I; 0.4≤x≤1.7 and −0.9≤y≤−x+2). Still further, the sulfide solid electrolyte can be a lithium-boron-sulfur electrolyte, for example, having a formula of Li₅B₇S₁₃, Li₂B₂S₅, Li₃BS₃, or Li₉B₁₉S₃₃. Even further, the sulfide solid electrolyte can include an admixture of sulfide solid electrolytes. In one example, the admixture includes a lithium-phosphorus-sulfur electrolyte and lithium-boron-sulfur electrolyte.

In another instance, the solid electrolyte includes an oxide solid electrolyte. In still another instance, the solid electrolyte includes an oxysulfide solid electrolyte. The solid electrolytes in Zhao, et. al. Electrochemical Energy Reviews (2019) 2:574-605 (doi.org/10.1007/s41918-019-00048-0) are incorporated herein by reference in their entirety.

The admixture can further include a conducting agent. Herein, a conducting agent is an electrically conductive material that is inactive to lithiation during the cycling of a lithium ion battery. In one example, the conducting agent can be a conductive carbon, for example, C45 and/or C65, a carbon nanofiber, a carbon nanotube, or mixtures thereof. In another example the conducting agent can be a transition metal or transition metal alloy, for example copper, nickel, or alloys thereof. Non-limiting examples of the conducting agent are acetylene black, ketjen black, natural graphite, artificial graphite, carbon black, carbon fiber, and metal powder and metal fiber of, for example, copper, nickel, aluminum or silver. In some embodiments at least one conducting material such as polyphenylene derivatives may be used in combination. Any conducting agent available in the art may be used. The above-described crystalline carbonaceous materials may be further added as the conducting agent. Preferably, the admixture includes about 1 wt. % to about 15 wt. % of the conducting agent. In another example, the admixture can include, consists essentially of, or consist of the amorphous silicon nanocrystals, the solid electrolyte, and the conducting agent.

The admixture can still further include a binder. Herein a binder is a compound included in the admixture for the purpose of improving mechanical stability of the admixture during use in a lithium ion battery or during the process of preparing the lithium ion battery, including forming an anode that includes the admixture. In one instance, the binder includes an organic polymer. Examples of the conventional binder are a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer, but are not limited thereto. In another instance the binder can be an inorganic material that reacts with the amorphous silicon nanocrystals and/or the solid electrolyte. Examples of inorganic materials include but are not limited to polysulfides, carbo-sulfides, polyselenides, carbo-selenides, polythioselenides, and mixtures thereof. Any material available as a binding agent in the art may be used. Any material available as a binding agent in the art may be used. In another instance, the binder includes a cross-linked organic polymer. Preferably, the admixture includes about 1 wt. % to about 15 wt. % of the binder. In another example, the admixture can include, consists essentially of, or consist of the amorphous silicon nanocrystals, the solid electrolyte, and the binder. In still another example, the admixture can include, consists essentially of, or consist of the amorphous silicon nanocrystals, the solid electrolyte, about 1 wt. % to about 15 wt. % of a conducting agent, and the binder.

Another embodiment is an admixture for use in an anode of a lithium ion battery that includes a plurality of amorphous silicon nanocrystals carrying a surface coating that is less than about 50 atom % silicon; and a solid electrolyte. Preferably, the surface coating is a distinct phase carried on the surface of the amorphous silicon nanocrystals. The surface coating can, itself, be amorphous or crystalline (e.g., as shown by TEM analysis), preferable the surface coating is amorphous.

In one instance, the surface coating has a thickness of less than about 10 nm, 9 nm, 8 nm, 7 nm, 6 nm, 5 nm, 4 nm, 3 nm, or 2 nm; the surface coating can further have a thickness greater than about 0.1 nm, 0.2 nm, 0.3 nm, 0.4 nm, 0.5 nm, 0.6 nm, 0.7 nm, 0.8 nm, 0.9 nm, or 1 nm. In another instance, the surface coating has a thickness of about 1 nm to about 20 nm, about 1 nm to about 15 nm, about 1 nm to about 10 nm, or about 1 nm to about 5 nm. The thickness of the surface coating can, in one example, be determined by EDS-TEM.

Preferably, the surface coating includes, consists essentially of, or consists of silicon and oxygen, sulfur, selenium, nitrogen, phosphorous, carbon, boron, aluminum, or a mixture thereof. In one instance, the surface coating includes sulfur and can further include carbon. In another instance, the surface coating includes oxygen. Specific examples of surface coatings include silicon sulfides, silicon-carbo-sulfides, silicon oxides, silicon sub-oxides, silicon oxysulfides, silicon carbo-oxides, and silicon carbo-oxysulfides. In one specific example, the surface coating can have a formula of SiOₓ (1≤x≤2), SiSₓ (1≤x≤4), SiOS, SiCSₓ (1≤x≤2), SiOₓN_{y} (0≤x≤2; 0≤y≤2), Si₃N₄, or SiCₓ (1≤x≤6). In another specific example, the surface coating includes aluminum and oxygen. Another example includes a surface coating that features a silicon phosphosulfide (SiPₓS_{y}), or a silicon borosulfide (SiBₓS_{y}).

While the surface coated amorphous silicon nanocrystals can be admixed with any of the above described solid electrolytes, there is, preferably, some compositional homogeneity between the surface coating and the solid electrolyte. That is, in instances where the surface coating includes sulfur, for example as a silicon sulfide, a silicon carbosulfide, or a silicon oxysulfide, the solid electrolyte is a sulfide solid electrolyte and/or an oxysulfide solid electrolyte.

In specific examples, the surface coating can be applied to the amorphous silicon nanocrystals after formation of the amorphous domains by the chemical reaction of the amorphous silicon nanocrystals sans surface coating with a surface coating agent. Examples, of surface coating agents includes O₂, Sₓ (elemental sulfur, 4≤x≤20), M₂Sₓ (polysulfides, for example lithium polysulfide (Li₂Sₓ), sodium polysulfide, potassium polysulfide, ammonium polysulfide, where x can range from 1 to about 25), P₂5₅, P₂Se₅, CO₂, CO, COS, CS₂, COSe, CSe₂, or mixtures thereof. The amorphous silicon nanocrystals can be made by processes known in the silicon industry, including but not limited to laser-driven shock compression of silicon nanocrystals or the rapid cooling of a silicon melt.

Yet another embodiment is an anode for use in lithium ion batteries comprising any one of the compositions described above. In one instance, the anode includes an admixture of a plurality of amorphous silicon nanoparticles and a solid electrolyte adhered to a current collector; wherein the anode has not undergone an initial-charging cycle. As is understood in the art, the initial-charging cycle is the first step in providing a functioning battery after the assembly of the components (e.g., anode and cathode) into a cell. As used herein, the initial-charging cycle is an application of a voltage to a cell that drives lithium into the anode. In a preferable

instance, the amorphous silicon nanoparticles, in an anode that has yet to undergo an initial-charging cycle, are substantially free of lithium.

The admixture carried on the current collector (the anode) can further include a conducting agent. In one example, the conducting agent can be a conductive carbon, for example, C45 and/or C65, a carbon nanofiber, a carbon nanotube, or mixtures thereof. In another example the conducting agent can be a transition metal or transition metal alloy, for example copper, nickel, or alloys thereof. Preferably, the admixture includes about 1 wt. % to about 15 wt. % of the conducting agent. Non-limiting examples of the conducting agent are acetylene black, ketjen black, natural graphite, artificial graphite, carbon black, carbon fiber, and metal powder and metal fiber of, for example, copper, nickel, aluminum or silver. In some embodiments at least one conducting material such as polyphenylene derivatives may be used in combination. Any conducting agent available in the art may be used. The above-described crystalline carbonaceous materials may be further added as the conducting agent.

The admixture carried on the current collector (the anode) can further include a binder. The binder preferably improves the mechanical stability of the admixture during use in a lithium ion battery or during the process of preparing the lithium ion battery, including forming an anode that includes the admixture. In one instance, the binder includes an organic polymer. In another instance, the binder includes a cross-linked organic polymer. Preferably, the admixture includes about 1 wt. % to about 15 wt. % of the binder. Examples of the conventional binder are a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer, but are not limited thereto. In another instance, the binder can be an inorganic material that reacts with the amorphous silicon nanocrystals and/or the solid electrolyte. Examples of inorganic materials include but are not limited to polysulfides, carbo-sulfides, polyselenides, carbo-selenides, polythioselenides, and mixtures thereof. Any material available as a binding agent in the art may be used.

Still another embodiment is a cell utilizing the above described anode. Herewith, the cell shows less than 20%, 10%, 9%, 8%, 7%, 6%, 5%, 4%, 3%, 2%, or 1% first cycle capacity loss. Alternatively, the first columbic efficiency of the cell is preferably above about 80%, 90%, 91%, 92%, 93%, 94%, 95%, 96%, 97%, 98%, or 99%. In another instance, the herein described anode has a “Standard-FCE” value that is about 5% greater than a “Standard-FCE” value of an analogous anode prepared with crystalline silicon nanocrystals; where the crystalline silicon nanocrystals individually comprising amorphous silicon domains and crystalline silicon domains, and where the atom ratio of amorphous silicon domains to crystalline silicon domains is in the range of about 1:1000 to about 1:5. Herewith, the Standard-FCE value is determined from two identical cell builds wherein the only difference between the cells, including composition and means of fabrication, is the utilization of the amorphous silicon nanocrystals and the crystalline silicon nanocrystals.

Yet still another embodiment is a process of preparing an anode for use in a lithium ion battery. The process, preferably, includes providing a plurality of amorphous silicon nanocrystals (e.g., those described above) and providing a solid electrolyte (e.g., those described above). The plurality of amorphous silicon nanocrystals and the solid electrolyte are then admixed and thereafter the admixture is affixed to a current collector. In another instance, the amorphous silicon nanocrystals and the solid electrolyte can be contemporaneously or step-wise applied to the current collector (not premixed) and then the combination affixed to the current collector. The process can include pressing and/or heating the admixture adjacent to the current collector thereby adhering the solid electrolyte to a surface of the amorphous silicon nanocrystals and, preferably, to the current collector. In one preferable instance, adhering the solid electrolyte to the surface of the amorphous silicon nanocrystals includes forming a chemical bond therebetween, adhering can include forming a physiochemical interaction between the two species, can include mechanical bonding between the two species, or a combination thereof. The process can further include admixing a binder with the amorphous silicon nanocrystals and the solid electrolyte.

While the compositions and methods of this invention have been described in terms of preferred embodiments, it will be apparent to those of skill in the art that variations may be applied to the compositions and/or methods in the steps or in the sequence of steps of the method described herein without departing from the concept, spirit and scope of the invention. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the invention as defined by the appended claims.

What is claimed:

1. An admixture for use in an anode of a lithium ion battery, the admixture comprising:
about 20 wt. % to about 75 wt. % of a plurality of amorphous silicon nanocrystals; and
about 80 wt. % to about 25 wt. % of a solid electrolyte.

2. The admixture of claim 1 further comprising about 1 wt. % to about 15 wt. % of a conducting agent.

3. The admixture of claim 2, wherein the admixture consists essentially of the amorphous silicon nanocrystals, the solid electrolyte, and the conducting agent.

4. The admixture of claim 1 further comprising about 1 wt. % to about 15 wt. % of a binder.

5. The admixture of claim 4, wherein the admixture consists essentially of the amorphous silicon nanocrystals, the solid electrolyte, and the binder.

6. The admixture of claim 4, wherein the admixture consists essentially of the amorphous silicon nanocrystals, the solid electrolyte, about 1 wt. % to about 15 wt. % of a conducting agent, and the binder.

7. The admixture of claim 1, wherein the amorphous silicon nanocrystals individually comprise amorphous silicon domains and crystalline silicon domains;
wherein the crystalline silicon domains have an average crystalline domain size of less than 20 nm; and
wherein an atom ratio of silicon in the amorphous silicon domains to silicon in the crystalline silicon domains is in the range of about 1:1 to about 1000:1.

8. The admixture of claim 7, wherein the ratio of amorphous silicon domains to crystalline silicon domains is in the range of about 2:1 to about 10:1.

9. The admixture of claim 7, wherein the average crystalline silicon domain size is between about 10 nm and about 20 nm.

10. The admixture of claim 1, wherein the solid electrolyte includes a sulfide solid electrolyte.

11. The admixture of claim 1, wherein the solid electrolyte includes an oxide solid electrolyte.

12. The admixture of claim 1, wherein the solid electrolyte includes an oxysulfide solid electrolyte.

13. An anode for use in lithium ion batteries, the anode comprising:
the admixture of claim 1; wherein
the admixture is adhered to a current collector and has not undergone an initial-charging cycle.

14. An admixture for use in an anode of a lithium ion battery, the admixture comprising:
a plurality of amorphous silicon nanocrystals carrying a surface coating that is less than about 50 atom % silicon; and
a solid electrolyte.

15. The admixture of claim 14, wherein the surface coating consists essentially of silicon and oxygen, sulfur, selenium, nitrogen, phosphorous, carbon, boron, aluminum, or a mixture thereof.

16. The admixture of claim 15, wherein the surface coating includes sulfur.

17. The admixture of claim 16, wherein the surface coating further includes carbon.

18. The admixture of claim 16, wherein the solid electrolyte includes a sulfide solid electrolyte and/or an oxysulfide solid electrolyte.

19. The admixture of claim 15, wherein the surface coating includes oxygen.

20. The admixture of claim 14, wherein the surface coating has a thickness of less than about 10 nm, 9 nm, 8 nm, 7 nm, 6 nm, 5 nm, 4 nm, 3 nm, or 2 nm.

21. The admixture of claim 14, wherein the admixture includes about 20 wt. % to about 75 wt. % of the plurality of amorphous silicon nanocrystals and about 80 wt. % to about 25 wt. % of the solid electrolyte.

22. An anode for use in lithium ion batteries, the anode comprising:
the admixture of claim 14; wherein
the admixture is adhered to a current collector and has not undergone an initial-charging cycle.
